(19) United States
(12) Patent Application Publication
(10) Pub. No.: US 2004/0003033 A1
(43) Pub. Date: Jan. 1, 2004

(54) Method and system for generating a web service interface

(76) Inventors: Yury Kamen, Foster City, CA (US); Bruce K. Daniels, Capitola, CA (US); Robert N. Goldberg, Emerald Hills, CA (US); Syed M. Ali, Sunnyvale, CA (US)

Correspondence Address: ROSENTHAL & OSHA L.L.P. / SUN, 1221 MCKINNEY, SUITE 2800, HOUSTON, TX, 77010, US

(21) Appl. No.: 10/184,479

(22) Filed: Jun. 27, 2002

(51) Int. Cl. G06F 15/16

(52) U.S. Cl. 709/203; 709/224

(57) ABSTRACT

A method for generating a web service interface including monitoring traffic between a web-based application and a client, generating a web service description using the monitored traffic, and generating an internal mapping using the monitored traffic allowing a web service method call to be directed to the web-based application using the internal mapping.

### BACKGROUND OF INVENTION

As new technological developments emerge, there may be a desire to move from legacy systems to newly developed ways of computing and executing business transactions and methodologies. Business transactions and methodologies are increasingly executed using web-based applications. There are millions of existing web-based applications running on a variety of platforms integrated into a variety of network architectures. Examples of web-based applications include Common Gateway Interface (CGI) applications, Systems Applications and Products in Data Processing (SAP) applications, structured query language (SQL) applications, web sites, etc.

The web site is the most common of web-based applications. In a general sense, a web site may be considered all computer files accessed by the general public using a uniform resource locator (URL) which references a domain name. The web site typically includes all executable files, text files, Hyper Text Markup Language (HTML) files, Common Gateway Interface (CGI) scripts, images, and graphics, which may be viewed, linked together, or downloaded as a single interactive unit.

FIG. 1 shows a typical network system running a web-based application. The network includes a client (10) and a server (12) connected over a wide area network (WAN) (14), such as the Internet. The server (12) hosts a web-based application, e.g., a website (16), which is created by linking web pages, e.g., web page (18). The server (12) typically handles such functions as security, administrative controls, and caching. The server (12) receives requests, e.g., a request for a particular web page (18), initiated by the client (10), using Hypertext Transfer Protocol (HTTP). Once the request passes filtering requirements, e.g., passing a firewall (not shown), the server (12) acts on the behalf of the client (10) and accesses the requested web page (18). The requested web page (18) is returned by the server (12) to the client (10) by relating the requested web page (18) to the original request.

While the network system shown in FIG. 1 is a two-tier architecture, another network system may have a multi-tier architecture, where additional servers, databases, etc. are located between the client (10) and the server (12). Examples of servers may include web servers, application servers, database servers, etc. Examples of databases may include International Business Machines (IBM™) DB2, Microsoft™ Access, Oracle™ database, Sybase™ database, etc.

Web services operate in a similar architecture to web sites. Web services are reusable software components that are accessible over a WAN and can be considered general-purpose architecture for distributed systems, which are location, platform, and language independent. FIG. 2 shows a typical network system running a web service. The network includes a web service client (22), a server (24), and a web service registry (26) connected over a WAN (14). The web service client (22) uses a web browser or protocol messages, e.g., Service Oriented Architecture Protocol (SOAP) messages, to access the server (24) or the web service registry (12). The web service registry (12) stores a description of the web service.

One such description is a Web Services Description Language (WSDL) description. The WSDL description provides an overview of the web service, including the functions of the web service, where a web service is located, and how to invoke the web service. The WSDL description may be stored with the web service on the server (24) or may be registered in the web service registry (26). The web service client (22) may access the server (24) and invoke the web service as defined by the WSDL description using SOAP messages. The web service client (22) may also access the web service registry (26). One such example is a Universal Description Discovery and Integration (UDDI) registry, which allows information about businesses and web services to be published and queried. Enabling a web-based application as a web service can be expensive with respect to time, effort, and finance, due to the cost of rewriting and retesting the functionality of the web-based application as a web service.

### SUMMARY OF INVENTION

In general, in one aspect, the invention relates to a method for generating a web service interface comprising monitoring traffic between a web-based application and a client, generating a web service description using the monitored traffic, and generating an internal mapping using the monitored traffic allowing a web service method call to be directed to the web-based application using the internal mapping.

In general, in one aspect, the invention relates to a method for generating a web service interface comprising parsing source code of a web-based application, generating a web service description using the parsed source code, and generating an internal mapping using the parsed source code allowing a web service method call to be directed to the web-based application using the internal mapping.

In general, in one aspect, the invention relates to a web service interface generation system comprising a web-based application accessible by a client, a web service interface generator interposed between the web-based application and the client, wherein the web service interface generator: monitors traffic between the web-based application and the client, generates a web service description using the monitored traffic, and generates an internal mapping using the monitored traffic.

In general, in one aspect, the invention relates to a web service interface generation system comprising a web-based application accessible by a client, and a web service interface generator interposed between the web-based application and the client, wherein the web service interface generator: parses source code of the web-based application and the client, generates a web service description using the parsed source code, and generates an internal mapping using the parsed source code.

In general, in one aspect, the invention relates to a computer system for generating a web service interface comprising a processor, a memory, an input means, and software instructions stored in the memory for enabling the computer system under the control of the processor to monitor traffic between the web-based application and the client, generate a web service description using the monitored traffic, and generate an internal mapping using the monitored traffic allowing a web service method call to be directed to the web-based application defining the web services interface using the internal mapping.

In general, in one aspect, the invention relates to a computer system for generating a web service interface comprising a processor, a memory, an input means, and software instructions stored in the memory for enabling the computer system under the control of the processor to parse source code of the web-based application, generate a web service description using the parsing source code, and generate an internal mapping using the parsed source code allowing a web service method call to be directed to the web-based application defining the web services interface using the internal mapping.

In general, in one aspect, the invention relates to an apparatus to define a web services interface comprising means for monitoring traffic between a web-based application and a client using the web service interface generator, means for generating the web service description using the monitored traffic, and means for generating an internal mapping using the monitored traffic allowing a web service method call to be re-directed to the web-based application.

In general, in one aspect, the invention relates to an apparatus for generating a web service interface comprising means for parsing source code of a web-based application, means for generating a web service description using the parsed source code, and means for generating an internal mapping using the parsed source code allowing a web service method call to be directed to the web-based application using the internal mapping.

Other aspects and advantages of the invention will be apparent from the following description and the appended claims.

### BRIEF DESCRIPTION OF DRAWINGS

FIG. 1 shows a typical network system running a web-based application.

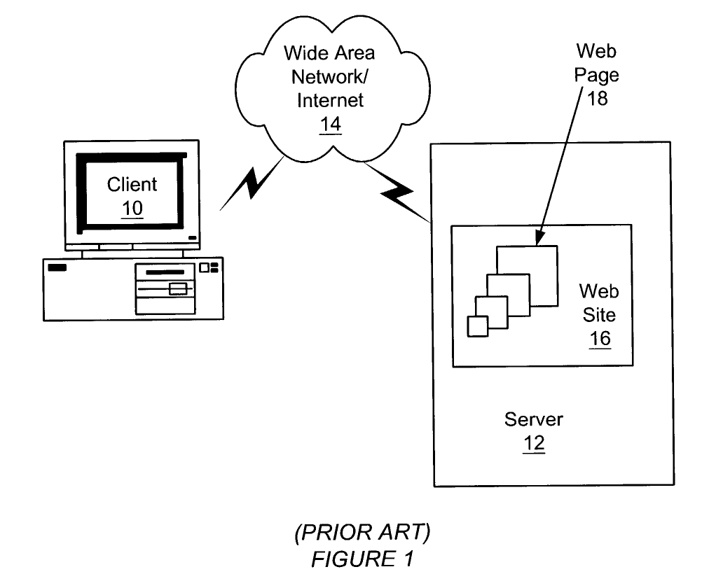

FIG. 2 shows a typical network system running a web service.

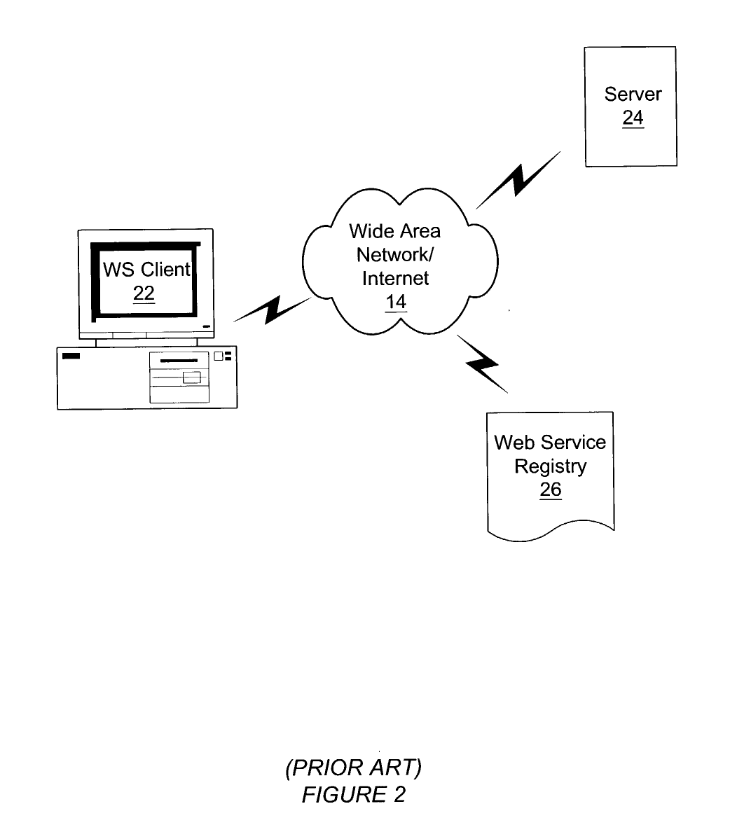

FIG. 3 shows a typical computer system.

FIG. 4 shows a network system running a web-based application in accordance with one embodiment of the invention.

FIG. 5 shows a network system running a web-based application in accordance with one embodiment of the invention.

FIG. 6 shows a network system running a web site in accordance with one embodiment of the invention.

FIG. 7 shows a flow chart of a process of generating a web service interface in accordance with one embodiment of the invention.

FIG. 8 shows a flow diagram for generating a web service interface in accordance with one embodiment of the invention.

FIG. 9 shows a flow chart of a process of deploying a web service interface in accordance with one embodiment of the invention.

### DETAILED DESCRIPTION

Exemplary embodiments of the invention will be described with reference to the accompanying drawings. Like items in the drawings are denoted by the same reference numbers throughout the figures for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

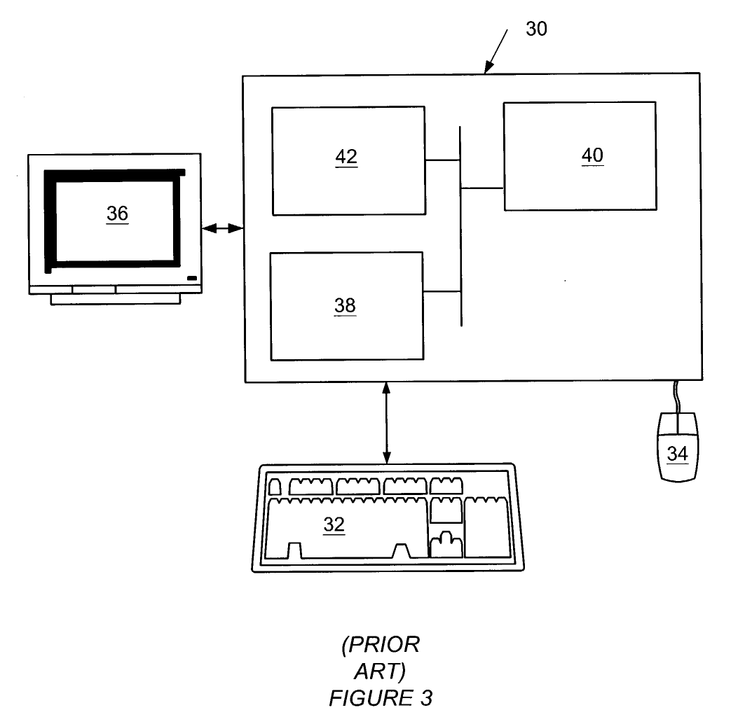

The invention may be implemented on virtually any type of computer regardless of the platform being used. For example, as shown in FIG. 3, a typical computer (30) includes a processor (40), associated memory (42), a storage device (38), and numerous other elements and functionalities typical of today's computers (not shown). The computer (30) may also include input means, such as a keyboard (32) and a mouse (34), and output means, such as a monitor (36). Those skilled in the art will appreciate that these input and output means may take other forms in an accessible environment.

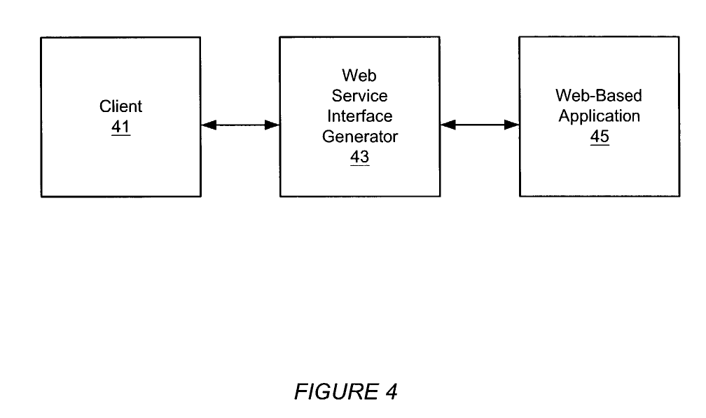

The invention relates to a method for generating a web services interface, allowing a web-based application to be used as a web service. FIG. 4 shows a network system running a web-based application in accordance with one embodiment of the invention. The network includes a client (41), a web service interface generator (43), and a web-based application (45). The client (41) may be any web-enabled device (e.g., a web-enabled personal digital assistant (PDA), a web-enabled cellular telephone, a computer system connected to a WAN, etc.) that accesses the web-based application (45). Additionally, a server running a script that accesses the web-based application (45) also acts as the client (41). The client (41) typically uses standard data exchange protocols (e.g., Internet Message Access Protocol (IMAP), Post Office Protocol (POP), Wireless Application Protocol (WAP), HTTP, etc.) to access the web-based application (45). The client (41) sends data to the web-based application (45), generating traffic. Examples of traffic include HTTP “get” request, HTTP “put” request, HTTP “post” request, POP “rcvd” request, POP “retr” request, POP “noop” request, etc.

The web service interface generator (43) is interposed between the client (41) and the web-based application (45). The web service interface generator (43) monitors the elements of traffic initiated by the client (41). Using the elements of traffic, the web service interface generator (43) generates a web service interface containing a web service description and an internal mapping. The web service description provides an overview of the web service, i.e., functions of the web service, where the web service is located, and how to invoke the web service. The internal mapping contains information necessary for method calls initiated by a web service client (41) to access a particular point of content in the web-based application (45). For example, if the web-based application (45) is an e-commerce web site the particular point of content may be a web page.

In one embodiment of the invention, the web service description is written in WSDL. Additionally, the web service description and the internal mapping may be modified by a user to produce a user modification, e.g., specifying which functions of the web-based application are to be aggregated into the web service. Once modified, the web service interface includes the web service description and internal mapping in addition to the user modification. In one embodiment of the invention, the web service interface generator may be hosted on the same server hosting the web-based application or the web service interface generator may be hosted on a different server than the server hosting the web-based application.

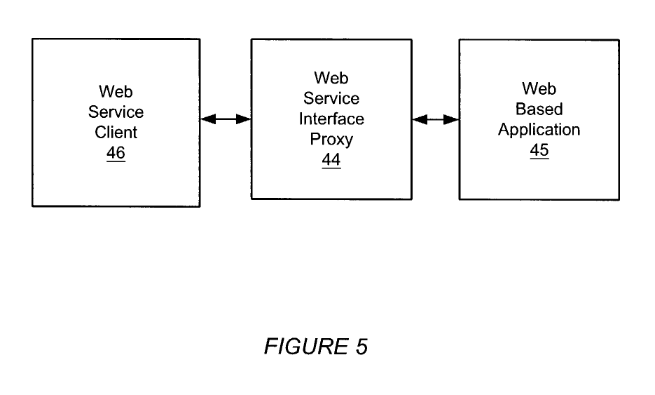

After the web service interface is generated, the web service interface may be deployed using a web service interface proxy. Upon deploying the web service interface, the web service interface proxy allows a web service client to access the web-based application. FIG. 5 shows a web service interface that is deployed on a network system in accordance with one embodiment of the invention. The network system includes a web service client (46), a web service interface proxy (44), and a web-based application (45). The web service client (46) uses the web service description to determine the functions provided by the web-based application (45). The web service client (46) may use a web browser or protocol messages (e.g., SOAP messages) to access the web-based application (45). The web service interface proxy (44) uses the internal mapping of the web service interface and translates data sent between the web service client (46) and the web-based application (45).

In one embodiment of the invention, the web service interface proxy may be hosted on the same server hosting the web service interface generator or the web service interface proxy may be hosted on a different server hosting the web service interface generator. Additionally, the web service registry may be accessed to identify the web service description of the web service provided by the web service interface proxy.

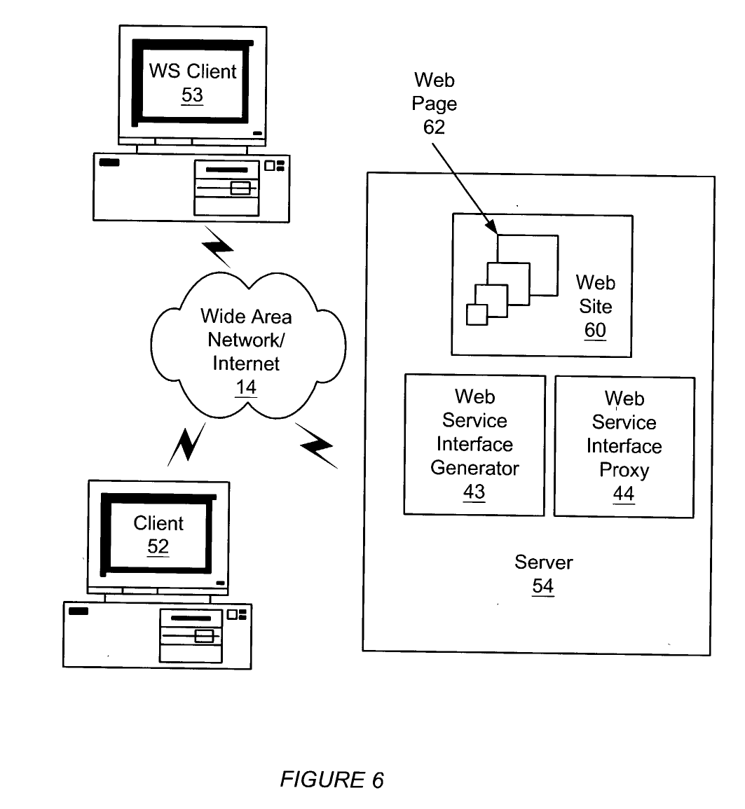

FIG. 6 shows an exemplary network system with a web service interface running a specific web-based application, a web site, in accordance with one embodiment of the invention. A client (52) accesses a web site (60). The client (52) is a computer system connected to a server (54) through a WAN (14). The server (54) hosts the web site (60) and a web service interface generator (43). The client (52) sends data using standard protocols, e.g., HTTP, to access the web site (60). The client (52) may send a HTTP “get” request to access a web page (62) of the web site (60).

The web service interface generator (43) is interposed between the client (52) and the web site (60). The web service interface generator (43) monitors the elements of traffic, namely the HTTP “get” request and other HTTP requests, e.g., “post” and “put.” The web service interface generator (43) generates a web service interface including a web service description and an internal mapping. The web service client (53) uses the web service description to determine the functions provided by the web site (60). The web service client (53) sends data using standard protocols, e.g., SOAP, to access the web site (60). The web service interface proxy (44) translates HTTP requests and responses into SOAP requests and responses, respectively. The translation between HTTP and SOAP allows for the web service client (53) to send data to the web site (60). Thus, the web service interface proxy (44) provides the requested web services to the web service client (53).

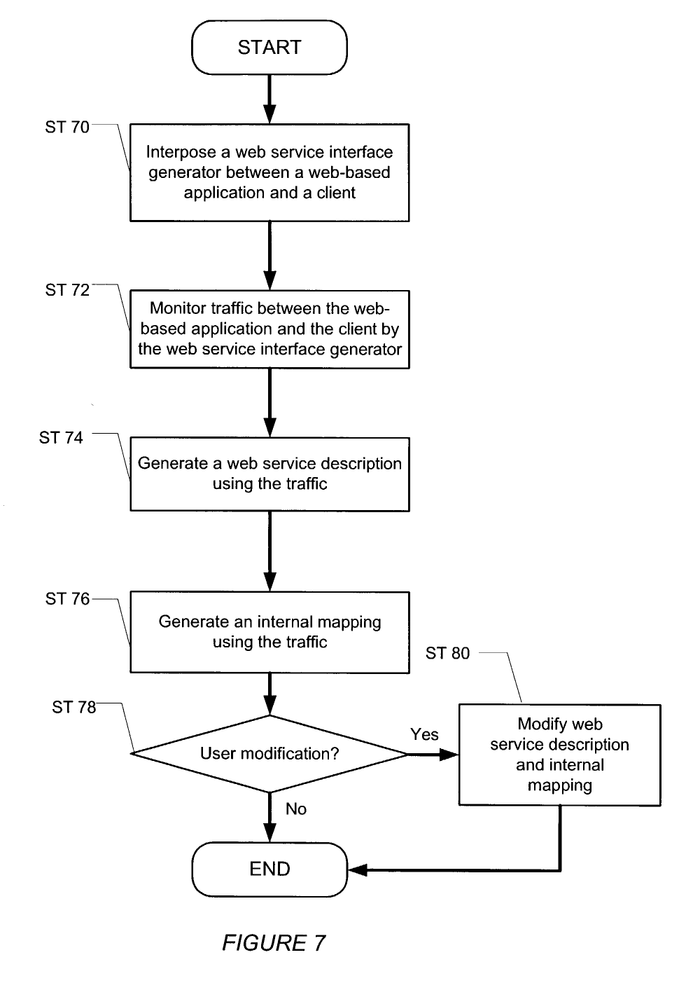

The method used to generate the web service interface discussed above is shown in FIG. 7. The flow chart in FIG. 7 shows the process of defining the web service interface by generating a web service description and an internal mapping in accordance with one embodiment of the invention. A web service interface generator is interposed between a web-based application and a client (Step 70). The client generates traffic by sending data to the web-based application. The traffic between the web-based application and the client is monitored by the web service interface generator (Step 72). The web service interface generator monitors the traffic by capturing an element of traffic, e.g., HTTP “post” request. The act of monitoring may be performed in a similar manner as a sniffer, which is known in the art as a program that monitors and analyzes traffic, typically detecting bottlenecks and problems. One such sniffer is the HTTP monitoring tool used by Forte for Java™ enterprise applications to provide HTTP network transaction information. The HTTP monitoring tool may be configured to monitor elements of traffic based on a plurality of characteristics and key terms. While monitoring may be performed in this manner, one skilled in the art can appreciate that a variety of ways exist to monitor traffic.

The web service interface generator generates the web service description (Step 74) by parsing the key terms of the element of traffic into methods. The methods are defined by functions and attributes (e.g., type, input parameters, etc.) that the element of traffic transports between the web-based application and the client. The act of parsing in Step 74 is known in the art as receiving input in the form of markup tags and breaking the tags or definitions into parts, e.g., objects, methods, and attributes to enable information to be extracted from the input. There are several ways known in the art to parse, e.g., bottom-up parsing, top-down parsing, recursive descent parsing, etc.

The traffic is also used to generate the internal mapping (Step 76) by parsing key terms of the element of traffic, specifically extracting information, such as input parameters, types, and URL. The web service interface generator generates an internal mapping that contains information necessary for methods called by a web service client to access the particular functionality of the web-based application.

If a user chooses to modify the web service description and internal mapping (Step 78), then the web service description and the internal mapping are displayed to the user in a form and manner in which to make the modification. The web service description and internal mapping are modified (Step 80) by the user, e.g., the user specifies a plurality of functions from different points of content into the web service interface. For example, in one embodiment of the invention, a graphical user interface (GUI) may provide radio buttons or check boxes to specify functions from different URLs the user may include in a particular web service interface. The user modification may also be specified by issuing a set of commands at a prompt. If a user chooses not to modify the web service description and internal mapping, the generation of the web service interface is complete. Upon completion of the generation of the web service interface, the web service interface includes the web service description, the internal mapping, and the user modifications (if any). By default, a web service interface is generated for each web page of the web-based application.

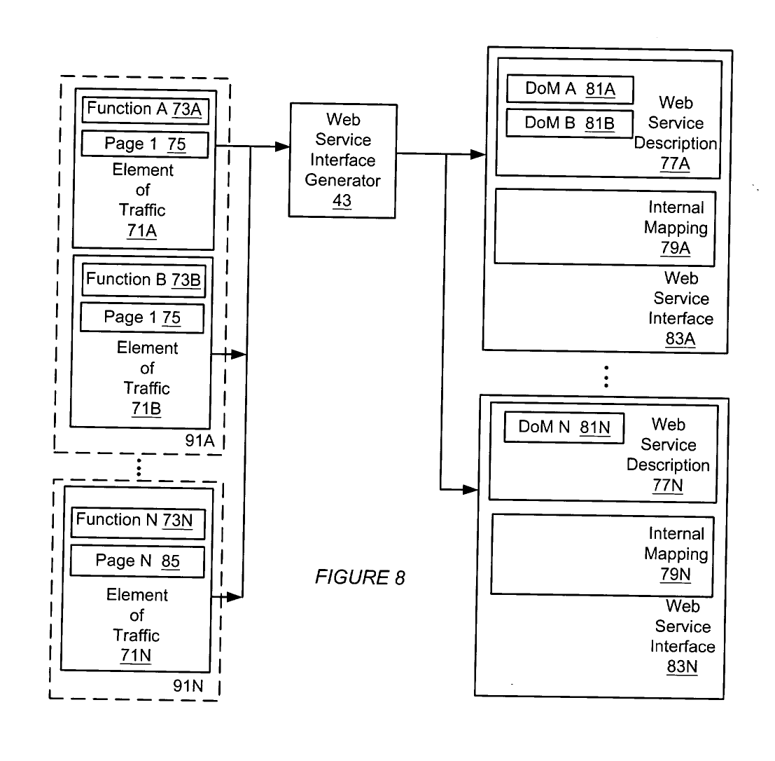

FIG. 8 shows a flow diagram of generating the web service interface in accordance with one embodiment of the invention. The web service interface generator (43) monitors elements of traffic (71A, 71B, 71N) from a web-based application. Using the elements of traffic associated with each web page (91A, 91N), the web service interface generator defines a set of web service interfaces (83A, 83N) by generating a set of web service descriptions (77A, 77N) and a set of internal mappings (79A, 79N) for each web page. The elements of traffic (71A, 71B, 71N) contain Function A (73A), Function B (73B), and Function N (73N), respectively. The elements of traffic associated with “Page 1” (91A) contain the URL “Page 1,” where the elements of traffic associated with a “Page N” (91N) contain the URL “Page N.” The web service interfaces (83A, 83N) are generated for every URL by default.

The web service descriptions (77A, 77N) are generated by parsing the functions (73A, 73B, 73N) of the elements of traffic (71A, 71B, 71N) into respective descriptions of methods (81A, 81B, 81N). Description of Method A (DoM A) (81A), description of Method B (DoM B) (81B), and description of Method N (DoM N) (81N) are derived from Function A (73A), Function B (73B), and Function N (73N), respectively.

The internal mappings (79A, 79N) are generated by parsing the URL of the respective elements of traffic associated with each page (91A, 91N). The internal mappings (79A, 79N) direct web service method calls initiated by the web service client to the appropriate URL (75, 85). The web service interface (83A) is defined by generating the web service description (77A) and the internal mapping (79A). Similarly, the web service interface (83N) is defined by generating the web service description (77N) and the internal mapping (79N).

The following code of an HTML form of a web page is an example of the definition of a web service interface:

Code Sample 1: HTML Code

| | |
|---|---|
| 1 | <html> |
| 2 | <body> |
| 3 | <form method=“POST” action=“http://www.john_doe_site.com/confirm”> |
| 4 | <p> |
| 5 | First Name <input type=“text” name= “firstName” size=“27” value=“John”> |
| 6 | </p> |
| 7 | <p> |
| 8 | Last Name <input type=“text” name= “lastName” size= “27” value=“Doe”> |
| 9 | </p> |
| 10 | <p> |
| 11 | <input type=“submit” value=“Submit” name=“SubmitData”> |
| 12 | <input type=“submit” value=“Validate” name=“ValidateData”> |
| 13 | </p> |
| 14 | <input type=“hidden” name=“clientid” va1ue=”abcdefg123”> |
| 15 | </form> |
| 16 | </body> |
| 17 | </html> |

Applying the method described in FIG. 7, using Code Sample 1, the “post” request is monitored by the web service interface generator (58). In monitoring, the “post” request is captured and parsed to analyze the HTML form structure (i.e., the key term or tags define in the HTML form).

The key terms are parsed and used in the web service description. For example, the two methods described in the web service description use information in lines 3, 11, and 12 of Code Sample 1. In line 3, the “post” method is used to submit the contents of the HTML form. Further, the attribute “action” defines where the HTML form is processed, i.e., “http://www.john_doe_site.com/confirm.” In line 11 and 12 of Code Sample 1, the “submit” attribute identifies an input action of submitting the contents of the HTML form. The value of the argument in line 11 is “Submit” and the name of the argument processed by the CGI script is “SubmitData.” The value of the argument in line 12 is “Validate” and the name of the argument processed by the CGI script is “ValidateData.”

The three parameters described in the web service description use information in lines 5, 8, and 14 of Code Sample 1. In both lines 5 and 8, the “text” attribute identifies a text box for inputting alphanumeric characters. The value of the argument in line 5 is “John” and the name of the argument to be processed by the CGI script is “firstName.” The value of the argument in line 8 is “Doe” and the name of the argument to be processed by the CGI script is “lastName.” In line 14, the “hidden” attribute identifies information regarding state of the HTML form not to be changed by the client, but necessary to process the HTML form. The value of the argument in line 14 is “abcdefg123” and the name of the argument to be processed by the CGI script is “clientid.”

In one embodiment of the invention, source code of the web-based application, e.g., HTML, Java™ Server Pages (JSP), is used to generate the internal mapping and the web service description.

The following web services description with two methods defined within is generated from the code of the HTML form in Code Sample 1:

Code Sample 2: Web Service Description

| | |
|---|---|
| 1 | <?xml version=‘1.0’ encoding=‘UTF-8’?> |
| 2 | <definitions name=‘ConfirmWebService’ |
| 3 | xmlns:soap=‘http://schemas.xmlsoap.org/wsdl/soap/’ |
| 4 | xmlns:xsd=‘http://www.w3.org/2001/XMLSchema’ |
| 5 | xmlns=‘http://schemas.xmlsoap.org/wsdl/‘xmlns:SOAP- |
| 6 | ENC=‘http://schemas.xmlsoap.org/soap/encoding/’ |
| 7 | targetNamespace=‘http://localhost:8081/ConfirmWebService/servlet/rpcrouter’ |
| 8 | xmlns:tns=‘http://localhost:8081/ConfirmWebService/servlet/rpcrouter’ |
| 9 | xmlns:xsd1=‘http://localhost:8081/ConfirmWebService/servlet/rpcrouter/schema’ |
| 10 | > |
| 11 | |

| | |
|---|---|
| 12 | <types> |

| | |
|---|---|
| 13 | <xsd:schema xmlns:xsd=‘http://www.w3.org/2001/XMLSchema’ |

| | |
|---|---|
| 14 | targetNamespace=‘http://localhost:8081/ConfirmWebService/servlet/rpcrouter/sc |
| 15 | hema’> |

| | |
|---|---|
| 16 | </xsd:schema> |

| | |
|---|---|
| 17 | </types> |
| 18 | |
| 19 | <message name=‘submitInput’> |

| | |
|---|---|
| 20 | <part name=‘firstName’ type=‘xsd:string’/> |
| 21 | <part name=‘lastName’ type=‘xsd:string’/> |
| 22 | <part name=‘clientid’ type=‘xsd:string’/> |

| | |
|---|---|
| 23 | </message> |
| 24 | |
| 25 | <message name=‘submitOutput’> |
| 26 | </message> |
| 27 | |
| 28 | <message name=‘verifyInput’> |

| | |
|---|---|
| 29 | <part name=‘firstName’ type=‘xsd:string’/> |
| 30 | <part name=‘lastName’ type=‘xsd:string’/> |
| 31 | <part name=‘clientid’ type=‘xsd:string’/> |

| | |
|---|---|
| 32 | </message> |
| 33 | |
| 34 | <message name=‘verifyOutput’> |
| 35 | </message> |
| 36 | |
| 37 | |
| 38 | <portType name=‘ConfirmWebServiceport’> |

| | |
|---|---|
| 39 | <operation name=‘submit’> |

| | |
|---|---|
| 40 | <input message=‘tns:submitInput’/> |
| 41 | <output message=‘tns:submitOutput’/> |

| | |
|---|---|
| 42 | </operation> |
| 43 | |
| 44 | <operation name=‘verify’> |

| | |
|---|---|
| 45 | <input message=‘tns:verifyInput’/> |
| 46 | <output message=‘tns:verifyOutput’/> |

| | |
|---|---|
| 47 | </operation> |

| | |
|---|---|
| 48 | </portType> |
| 49 | |
| 50 | |
| 51 | <binding name= ‘ConfirmWebServiceBinding’ type=‘tns:ConfirmWebServicePort’> |

| | |
|---|---|
| 52 | <soap:binding style=‘rpc’ |
| 53 | transport=‘http://schemas.xmlsoap.org/soap/http’/> |
| 54 | |
| 55 | <operation name=‘submit’> |

| | |
|---|---|
| 56 | <soap:operation |
| 57 | soapAction=‘http://localhost:8081/ConfirmWebService/servlet/rpcrouter/s |
| 58 | ubmit’/> |
| 59 | <input> |

| | |
|---|---|
| 60 | <soap:body use=‘encoded’ namespace=‘urn:ConfirmWebService’ |
| 61 | encodingStyle=‘http://schemas.xmlsoap.org/soap/encoding/’/> |

| | |
|---|---|
| 62 | </input> |
| 63 | <output> |

| | |
|---|---|
| 64 | <soap:body use=‘encoded’ namespace=‘urn:ConfirmWebService’ |
| 65 | encodingStyle=‘http: //schemas .xmlsoap.org/soap/encoding/ ’/> |

| | |
|---|---|
| 66 | </output> |

| | |
|---|---|
| 67 | </operation> |
| 68 | |
| 69 | <operation name=‘verify’> |

| | |
|---|---|
| 70 | <soap:operation |
| 71 | soapAction=‘http://localhost:8081/ConfirmWebService/servlet/rpcrouter/v |
| 72 | erify’/> |
| 73 | <input> |

| | |
|---|---|
| 74 | <soap:body use=‘encoded’ namespace=‘urn:ConfirmWebService’ |
| 75 | encodingStyle=‘http://schemas.xmlsoap.org/soap/encoding/’/> |

| | |
|---|---|
| 76 | </input> |
| 77 | <output> |

| | |
|---|---|
| 78 | <soap:body use=‘encoded’ namespace=‘urn:ConfirmWebService’ |
| 79 | encodingStyle=‘http://schemas.xmlsoap.org/soap/encoding/’/> |

| | |
|---|---|
| 80 | </output> |

| | |
|---|---|
| 81 | </operation> |

| | |
|---|---|
| 82 | </binding> |
| 83 | |
| 84 | <service name=‘ConfirmWebService’> |

| | |
|---|---|
| 85 | <port name=‘ConfirmWebServicePort’ |
| 86 | binding=‘tns:ConfirmWebServiceBinding’> |

| | |
|---|---|
| 87 | <soap:address |
| 88 | location=‘http://localhost:8081/ConfirmWebService/servlet/rpcrouter’/> |

| | |
|---|---|
| 89 | </port> |
| 90 | |

| | |
|---|---|
| 91 | </service> |

| | |
|---|---|
| 92 | </definitions> |

In the code sample above referred to as Code Sample 2, the web service description (WSD) defines two methods “Submit” and “Verify,” corresponding the Submit action and Verify action defined using HTML in Code Sample 1. Specifically, the message tags (i.e., <message> and </message>) on lines 19-26 and lines 28-35 define the information that is passed between a web service client and the process running the web service. For example, the “SubmitInput” message on lines 19-23 contains three attributes, ‘firstname’, ‘lastName’, and ‘clientid.’ The attributes correspond to the attributes of the “Submit” action defined in Code Sample 1. The portType tags (i.e., <portType> and </port>) on lines 38-48, and the binding tags (i.e., <binding>, </binding> on lines 51-82) include the necessary information to allow the web service client to invoke the methods defined in the web service description (i.e., the “Submit Operation” is defined on lines 39-42 and 55-67, and the “Verify Operation” is defined on lines 44-48 and lines 69-82).

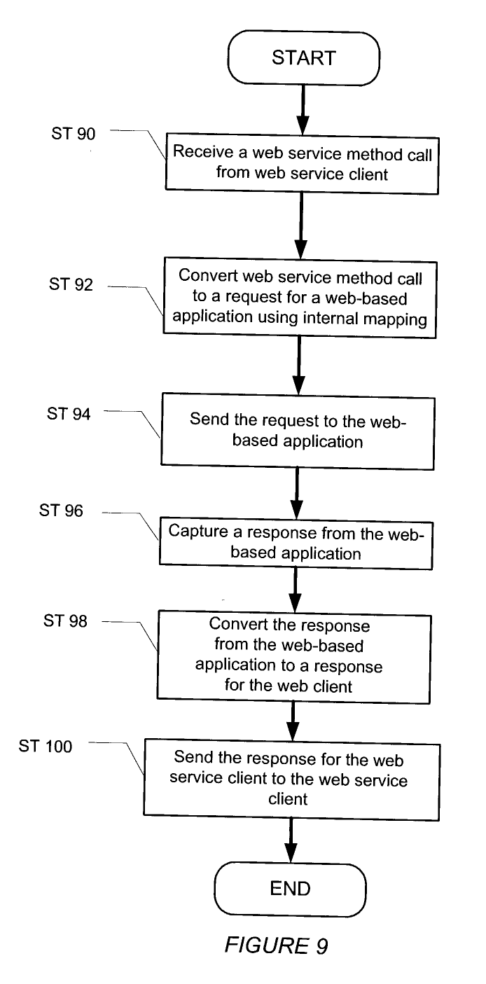

The web service interface is used by the web service interface proxy using the method shown in FIG. 9, which shows a process of deploying a web service interface in accordance with one embodiment of the invention.

The web service client uses a web service registry to discover the requested web service. The web service client determines how to access the web service using the web service description published in the web service registry. The web service client initiates a web service method call to access the web service using a web browser or by sending a set of protocol messages, namely SOAP messages.

The web service interface proxy receives the web service method call from the web service client (Step 90). The web service method call is converted to a request for a web-based application using the internal mapping (Step 92). In one embodiment of the invention, the web service method call is parsed and the data obtained from parsing the web service method call is inserted into a template. In one embodiment of the invention, the template contains tagged fields that allow the web service interface proxy to insert the data obtained from parsing the web service method call into the template. The result of inserting the data obtained from parsing the web service method call into the template is a request that can be understood by the web-based application. Returning to FIG. 9, the internal mapping re-directs the web service method call to the particular point of content. For example, the web service method call is converted to a HTTP request for a particular web page.

The web service interface proxy sends the request to the web-based application (Step 94). The web-based application processes the request and sends back a response. The web service interface proxy captures the response from the web-based application (Step 96). The web service interface proxy relates the response to the web service client (by associating the response to a destination address of the web service client) and converts the response to a protocol used by the web service client (Step 98). In one embodiment of the invention, the response is converted by inserting the response into an extensible mark-up language (XML) document. Further, the parameters initially sent with the request are also inserted into the XML document. For example, the HTTP response is related the web service client and converted to a SOAP response for the web service client.

The web service interface proxy sends the converted response to the web service client (Step 100). The web service interface proxy maintains the functionality of caching, security, etc. in processing requests and responses.

Consider the example where a web service client, using the method described in FIG. 9 wishes to access a stock quote web service. The stock quote web service is essentially an existing stock quote web site in which a web service interface has been generated in a manner described in FIG. 7 to allow web service clients to leverage the functions of the stock quote web site.

The web service description of the stock quote web service (generated by the web service interface generator) is published in the web service registry, e.g., a UDDI registry. The web service client initiates a web service method call described in the web service description of the stock quote web service. The web service method call uses SOAP over HTTP and is received by the web service interface proxy.

The web service interface proxy converts the web service method call into a HTTP request for the stock quote web site using the internal mapping (generated by the web service interface generator). Therefore, a “submit” method initiated by the web service client using SOAP with a stock name parameter of type string is converted to a HTTP “post” request with one parameter of type text and directed to the appropriate web page. The web service interface proxy sends the converted HTTP “post” request to the appropriate web page. The web page processes the HTTP “post” request and returns a HTTP “post” response containing the stock price corresponding to the requested stock name. The web service interface proxy captures the HTTP “post” response.

The HTTP “post” response is converted to a SOAP response containing the stock price corresponding to the stock name. The web service interface proxy sends the SOAP response to the web service client. If the web service client, wishes to make additional stock quote inquiries the web service interface proxy uses the cached web page to the retrieve stock price corresponding to the particular stock name. Additionally, the web service method calls (or requests) may pass firewalls to ensure the security of the stock quote web site.

Advantages of the invention may include one or more of the following in one or more embodiments. The invention allows for a web-based application to be used as a web service without the need for rewriting and retesting of web-based application as a web service. The generation of the web services interface allows a user to use a web-based application in a platform and language independent environment. The invention allows for the content and functionality of web-based application to be leveraged by web service clients. The invention allows for web service clients and non web-service clients to access the web-based application concurrently. The invention allows for automatic testing of the original web-based application using a web service client. Those skilled in the art will appreciate that the invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating a web service interface comprising:
monitoring traffic between a web-based application and a client;
generating a web service description using the monitored traffic; and
generating an internal mapping using the monitored traffic allowing a web service method call to be directed to the web-based application using the internal mapping.

2. The method of claim 1, further comprising:
providing the web service interface to a user for modification; and
generating a modified web service interface using the user modification.

3. The method of claim 2, wherein the user modification specifies functions for generating an aggregated web service interface using the user modification.

4. The method of claim 1, wherein the web service description is defined using a web services description language.

5. The method of claim 1, wherein the monitored traffic comprises hypertext transfer protocol requests.

6. A method for generating a web service interface comprising:
parsing source code of a web-based application;
generating a web service description using the parsed source code; and
generating an internal mapping using the parsed source code allowing a web service method call to be directed to the web-based application using the internal mapping.

7. The method of claim 6, further comprising:
providing the web service interface to a user for modification; and
generating a modified web service interface using the user modification.

8. The method of claim 7, wherein the user modification specifies functions for generating an aggregated web service interface using the user modification.

9. The method of claim 6, wherein the web service description is defined using a web services description language.

10. A web service interface generation system comprising:
a web-based application accessible by a client;
a web service interface generator interposed between the web-based application and the client,
wherein the web service interface generator: monitors traffic between the web-based application and the client, generates a web service description using the monitored traffic, and generates an internal mapping using the monitored traffic.

11. The system of claim 10, further comprising:
a user modification component for allowing a user to modify the web service description,
wherein the web service interface generator generates a modified web service description using a user modification generated using the user modification component.

12. The system of claim 11, wherein the user modification specifies functions for an aggregated web service interface.

13. The system of claim 10, wherein the web service interface generator is hosted by a server hosting the web-based application.

14. The system of claim 10, wherein the web service interface generator is hosted by a first server operatively connected to the client and a second server hosting the web-based application.

15. The system of claim 10, wherein the web service description is defined using a web services description language.

16. The system of claim 10, wherein the monitored traffic comprises hypertext transfer protocol requests.

17. A web service interface generation system comprising:
a web-based application accessible by a client; and
a web service interface generator interposed between the web-based application and the client,
wherein the web service interface generator: parses source code of the web-based application and the client, generates a web service description using the parsed source code, and generates an internal mapping using the parsed source code.

18. The system of claim 17, further comprising:
a user modification component for allowing a user to modify the web service description,
wherein the web service interface generator generates a modified web service description using a user modification generated using the user modification component.

19. The system of claim 18, wherein the user modification specifies functions for an aggregated web service interface.

20. The system of claim 17, wherein the web service interface generator is hosted by a server hosting the web-based application.

21. The system of claim 17, wherein the web service interface generator is hosted by a first server operatively connected to the client and a second server hosting the web-based application.

22. The system of claim 17, wherein the web service description is defined using a web services description language.

23. A computer system for generating a web service interface comprising:
a processor;
a memory;
an input means; and
software instructions stored in the memory for enabling the computer system under the control of the processor to:
monitor traffic between the web-based application and the client;
generate a web service description using the monitored traffic; and
generate an internal mapping using the monitored traffic allowing a web service method call to be directed to the web-based application defining the web services interface using the internal mapping.

24. The computer system of claim 23, the software instructions further for enabling the computer system under the control of the processor to:
receive a user modification via the input means of the web service interface,
wherein the software instructions further enable the computer system to generate a modified web service interface using the user modification.

25. The computer system of claim 24, wherein the user modification specifies functions for an aggregated web service interface using a user modification component.

26. The computer system of claim 23, wherein the web service description is defined using a web services description language.

27. The computer system of claim 23, wherein the traffic comprises hypertext transfer protocol requests.

28. A computer system for generating a web service interface comprising:
a processor;
a memory;
an input means; and
software instructions stored in the memory for enabling the computer system under the control of the processor to:
parse source code of the web-based application;
generate a web service description using the parsing source code; and
generate an internal mapping using the parsed source code allowing a web service method call to be directed to the web-based application defining the web services interface using the internal mapping.

29. An apparatus to define a web services interface comprising:
means for monitoring traffic between a web-based application and a client using the web service interface generator;
means for generating the web service description using the monitored traffic; and
means for generating an internal mapping using the monitored traffic allowing a web service method call to be re-directed to the web-based application.

30. An apparatus for generating a web service interface comprising:
means for parsing source code of a web-based application;
means for generating a web service description using the parsed source code; and
means for generating an internal mapping using the parsed source code allowing a web service method call to be directed to the web-based application using the internal mapping.
